(19) United States
(12) Patent Application Publication
(10) Pub. No.: US 2011/0061751 A1
(43) Pub. Date: Mar. 17, 2011

(54) Tilting Disc Swing Check Valve

(75) Inventor: Worrapong Jumpol, Prachapattana Sub-district (TH)

(73) Assignee: SIAM CAST IRON WORKS CO., LTD., Samutsakorn (TH)

(21) Appl. No.: 12/882,767

(22) Filed: Sep. 15, 2010

(30) Foreign Application Priority Data
Sep. 15, 2009 (TH) 0901004167

(51) Int. Cl. F16K 15/03

(52) U.S. Cl. 137/527

(57) ABSTRACT

A Tilting Disc Swing Check Valve that allows liquid to flow only in single direction is disclosed herein. The valve opens when liquid flows. When the flow stops, weight of valve's closing mechanism will swing back to close position and halt backflow. The closing mechanism of Tilting Disc Swing Check Valve is a part of swinging disc, attached by a hinge, and set at the slant angle to provide quick closing and reduces water hammer. Its hinge pin axis could be placed either vertically and horizontally. The Tilting Disc Swing Check Valve is recommended to be installed adjacent to a pump in order to prevent the pump's damage cause by liquid's backflow, and when the pump needs to be shut down for maintenance.

### BACKGROUND ARTS AND SCIENCES RELATED TO THE INVENTION

Water is a vital element of all lives in daily consumption since no plant or animal can survive without it. Nowadays, water supply system plays an important role, particularly to people in urban areas, supplying sufficient amount of clean water for residents as well as for extensive growth of the country's industrial and business development. At the same time, wastewater management system also becomes a major concern. In both water supply and wastewater systems, quality and efficiency of valves performs critical function in controlling pressure within pipelines. Various types of valves are hence designed to answer different objectives, from start and stop, control, inhibit backflow or redirecting flows. Tilting Disc Swing Check Valve is a type of valve that inhibits back flow. It is uniquely different from other conventional swing check valves. Generally, the disc of swing check valve will close slowly, and if there is any backflow in the pipeline, it will cause damages to the pump. If the disc closes fast, it will obstruct the water flow and create the water pressure losses during passing through the pipeline which called ‘Hear Loss’.

### CHARACTERISTICS AND PURPOSE OF THE INVENTION

Tilting Disc Swing Check Valve allows liquid to flow only in single direction. It opens when liquid flows. When the flow stops, weight of valve's closing mechanism will swing back to close position and halt backflow. The closing mechanism of Tiling Disc Swing Check Valve is a part of swinging disc, attached by a hinge, and set at a slant angle to provide quick closing and reduce water hammer. Its hinge pin axis could be placed either vertically or horizontally. The Tilting Disc Swing Check Valve is recommended to be installed adjacent to a pump in order to prevent the pump's damage caused by liquid's backflow, and when the pump needs to be shut down for maintenance.

### DISCLOSURE OF THE INVENTION

FIG. 1 illustrates the overall picture of tilting disc swing check valve, viewed three dimensionally and cross-sectional in angled position. Tilting disc swing check valve consists of Body (1), Cover (3) on top. Both parts are made of grey cast irons for operating pressure of not more than 10 bar, and spheroidal graphite cast iron for operating pressure of 16 bar and above. A cover gasket (14) is placed between the Body (1) and Cover (3). The body (1) and Cover (3) are held together with Cover bolt (13).

From the Body (1), there are square boss (18) protrude left and right, and End-Plate A (4) is placed with square Gasket (24) jointed on both sides The square boss (18) and the End-Plate A (4) is fit together with in End-Plated Bolt (11). At the lower part of the Body (1), a hollow cylindrical bar (25) protrudes perpendicularly to the Seat (17). End-Plate B (6) is fastened to the Body (1) with End-Plate Bolt (11).

FIG. 2 illustrates the tilting disc swing check valve, at its back view (water outlet). It shows the “small button” protruding from top flange of the Body (1) in order to limit an opening angle of the Disc (2). This part is called “Stopper (16)”.

FIG. 3 illustrates the tilting disc swing check valve in horizontal cut to show internal components, comprising of the Disc (2). The Disc (2) is made of spheroidal graphite cast iron, which will inhibit the flow in cases that there is no pressure or backflow in the pipeline. It will automatically open when pushed by fluid with enough pressure. An increasing amount of pressure will increase an opening angle of the Disc (2). However, a maximum angle of Disc (2) is limited by Stopper (16) that extrudes from the Body (1). This means the Disc (2) can open at maximum when operating pressure equals to an inclined degree between the Seat (17) and the Stopper (16), at the focal point on the center of hinge pin (9).

Disc Seat Ring (8) comes with two variations of materials. First is made of Nitrile Butadiene Rubber (NBR) or Ethylene Propylene Diene Rubber (EPDM). It has a round shape as shown in FIG. 11.

Second is made of metal-bronze or stainless steel. The metal Disc Seat Ring (8) comes in a similar shape of Body Seat Ring as shown in FIG. 12. Both types of Disc Seat Ring (8) can prevent leakage of any liquid around the seating surfaces. For the rubber Disc Seat Ring (8), one side of it will be fixed on the perimeter of the disc (19) as shown in FIG. 5. Another side will be pressed upon by Seat Holder (5) as shown in FIG. 7 which is made of spheroidal graphite cast iron, same material as the Disc (2). It holds the Disc Seat Ring (8) and the perimeter of the disc (19) together permanently and is also securely fastened by Seat Holder Bolt (12). Meanwhile, the metal Disc Seat (8) will be pressed up to the Disc (2), and will not need the Seat Holder (5).

FIG. 4 illustrates a cross-sectional and three dimensional view of the Body (1) showing internal structure consists of seating surface (17) in round shape. This area will be machined and provided with a groove for matching with a component called Body Seat Ring (7) which is made from bronze or stainless steel. For the valve with rubber Disc Seat Ring (8), Body Seat Ring (7) is as per FIG. 9. It will be assembled to the Body (1) by compression to increase the seating effectiveness of the Disc Seat Ring (8). For the valve with metal Disc Seat Ring (8), Body Seat Ring (7) is as per FIG. 10 and will be assembled to the Body (1) by threading. The surface of Body Seat Ring (7) that will contact with Disc seat ring (8) will be machined finely until it is very smooth. When the valve closed, and there is no any liquid or pressure in the pipeline, Disc Seat Ring (8) will be tightly pressed to Body Seat Ring (7) by the weight of the Disc (2). In case of backflow occurs, the Disc Seat Ring (8) will be tightly pressed to the Body Seat Ring (7), and inhibits the liquid passing the Disc (2).

FIG. 5 illustrates two views of the disc (2). Picture of the left is a back view, and picture on the right picture is the cut Section A-A picture, consist of the Disc (2) and two Arms (21). At the end of both arms (21), there is a boss (22) in round shape providing a groove (23) for the pin (10) The position of this groove will fit to the groove of hinge pin (9).

FIG. 6 illustrates the Cover (3) in a dome shape. It helps distribute energy of pressure. It prevents liquid leaks from top of the valve. Lifting Lug (26) at the top of cover is provided for easy handling especially in large valves.

FIG. 8 illustrates the Hinge Pin (9), a cylindrical bar with the length equals to dimension of square boss (18) that protrudes from left end and the right end of the Body (1). Made of stainless steel, it hooks the boss (22) of the Disc (2) to balance and align the Body Seat Ring (7) of the Body (1) and the Disc (2). At one end of the Hinge Pin (9), a square cut (28) is made in order to fix with weight (27) as shown in FIG. 13. In cases that the Disc (2) needs to be closed more rapidly, as in large valve, the boss (22) of the Disc (2) will be provided with groove (20) to fix the pin (10) at two ends as shown in FIG. 11. Made of stainless steel, the pin (10) holds the boss (22) of the disc (2) with hinge pin (9) securely to prevent the leakage.

The position of square boss (18) that protrude on both of left and right sides of the Body (1) will be drilled and insert with bushes (15) which is made of brass or bronze before assembling the Hinge Pin (9). The bushes (15) as shown in FIG. 12 will reduce the friction between square boss (18), which is made of spheroidal graphite cast iron and Hinge Pin (9) which of stainless steel and make the disc move easier.

### BRIEF DESCRIPTION OF THE DRAWINGS

FIG. 1 illustrates sectional view of tilting disc swing check valve showing internal components as three dimensional views.

FIG. 2 illustrates tilting disc swing check valve from the back side (water outlet).

FIG. 3 illustrates image cut lengthwise of tilting disc swing check valve for overall components in two dimensional views.

FIG. 4 illustrates the cut image of the body of tilting disc swing check valve showing the seating area.

FIG. 5 illustrates the disc of tilting disc swing check valve.

FIG. 6 illustrates the cover of tilting disc swing check valve.

FIG. 7 illustrates the seat holder of tilting disc swing check valve.

FIG. 8 illustrates the hinge pin of tilting disc swing check valve.

FIG. 9 illustrates the compressed type body seat ring of tilting disc swing check valve.

FIG. 10 illustrates the threaded type body seat ring of tilting disc swing check valve.

FIG. 11 illustrates the rubber disc seat ring of tilting disc swing check valve.

FIG. 12 illustrates the metal disc seat ring of tilting disc swing check valve.

FIG. 13 illustrates the key of tilting disc swing check valve.

FIG. 14 illustrates the bushes of tilting disc swing check valve.

FIG. 15 illustrates the lever and weight of tilting disc swing check valve.

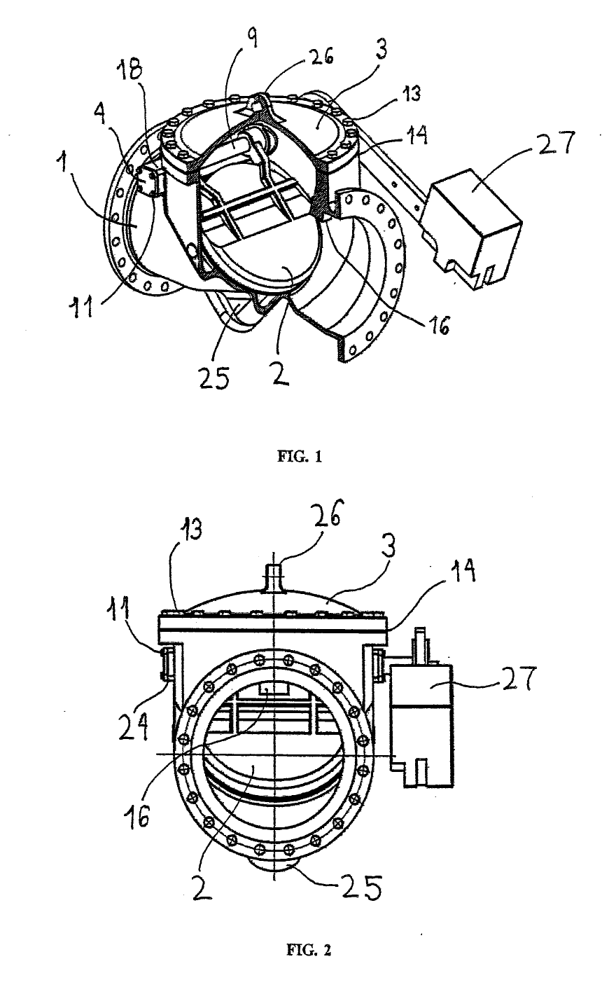

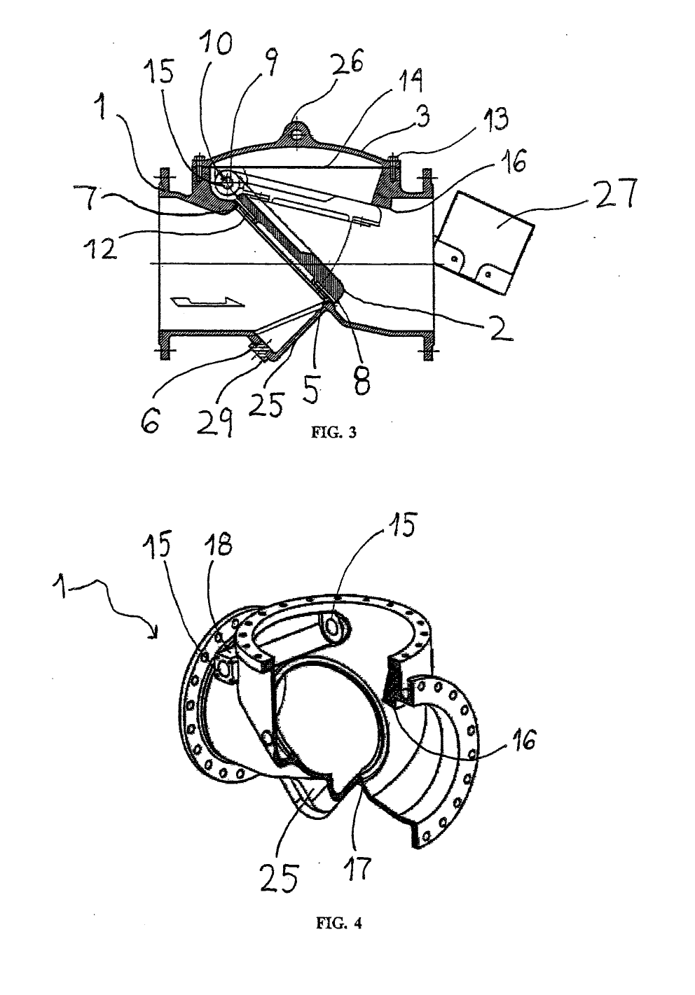

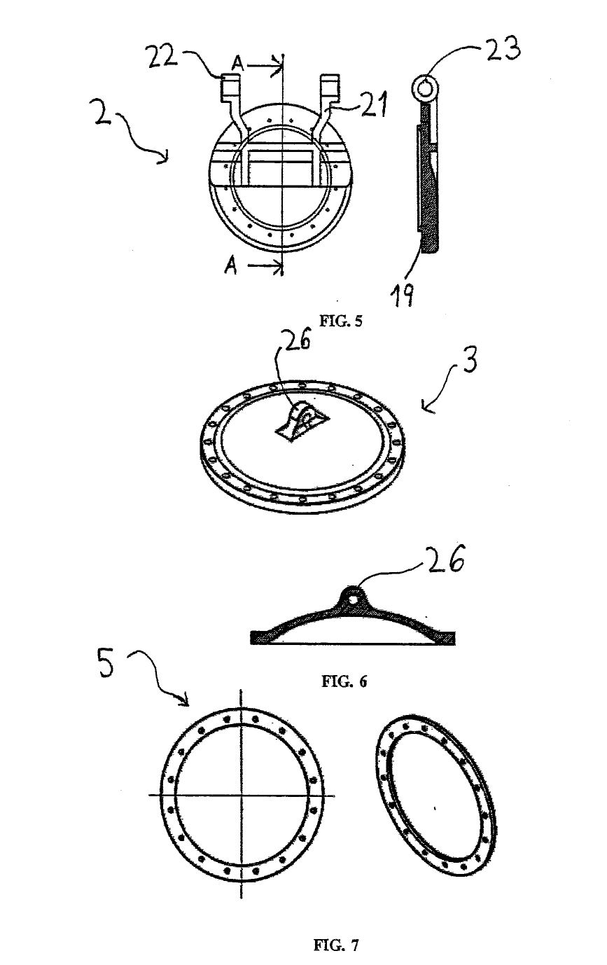

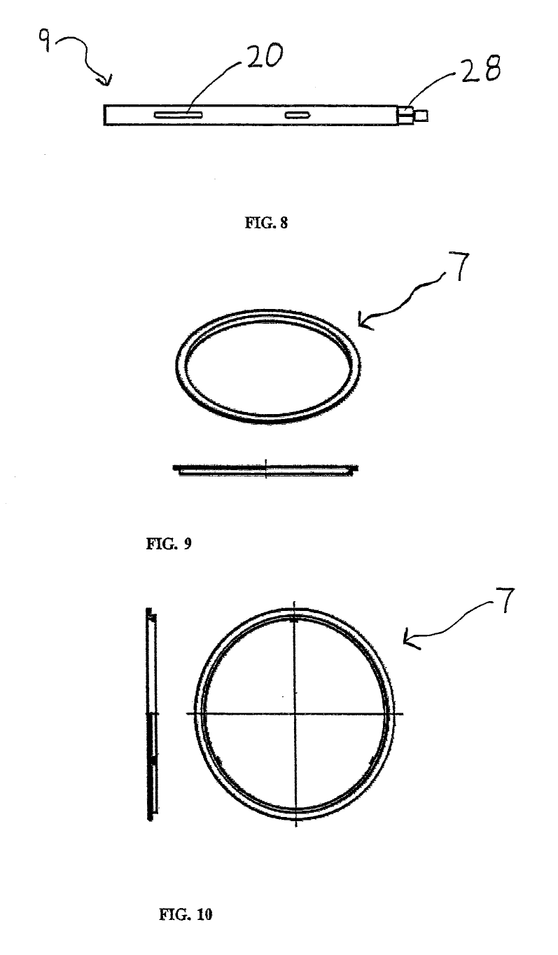

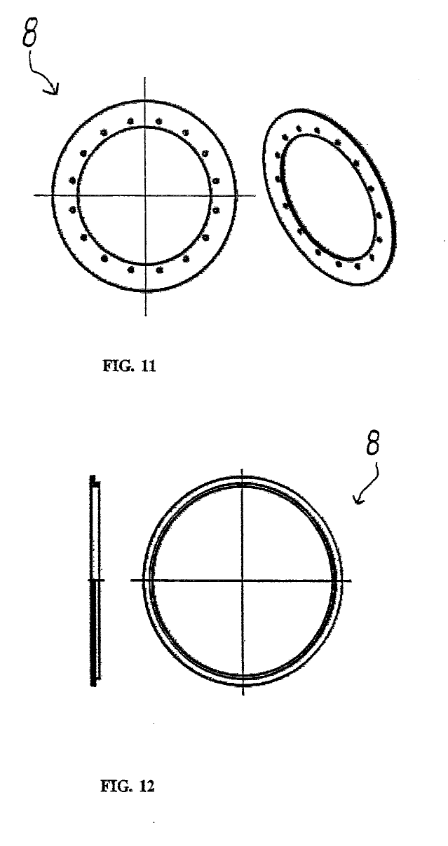

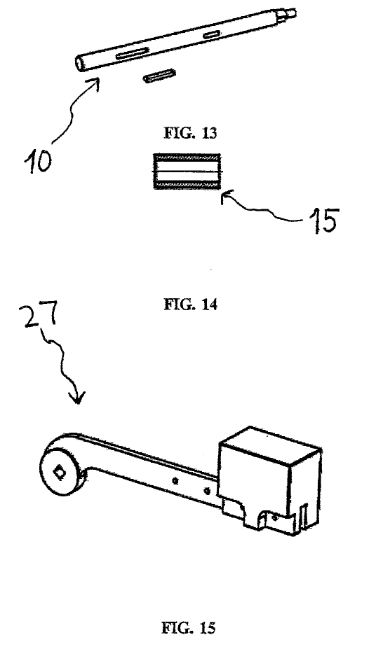

1-10. (canceled)

11. A tilting disc swing check valve comprising:
a body and a cover on top of the body,
wherein both parts are made of grey cast iron for an operating pressure of not more than 10 bar or a spheroidal graphite cast iron for an operating pressure of 16 bar and above,
wherein a cover gasket is placed between the body and the cover,
wherein the body and cover are held together with a cover bolt,
wherein the body contains square bosses protruding from left and right sides of the body, the square bosses being fixed with an end-plate A with a square gasket,
wherein at the lower part of the body, a hollow cylindrical bar protrudes perpendicularly to a seat, threaded by an end-plate B,
wherein a disc is made of spheroidal graphite cast iron, the disc inhibiting a flow when there is no pressure, as well as preventing backflow in a pipeline,
wherein the disc will automatically open when there is a fluid with enough pressure, and
wherein a higher pressure will lead to an increasing degree of the disc's opening angle, but not exceeding to a degree between a body seat ring and stopper, the disc having a center of a hinge pin as a rotating point.

12. The tilting disc swing check valve according to claim 11, wherein the valve further comprises a closing mechanism that includes the disc, a disc seat ring, and a seat holder assembled together,
wherein for the valve having a metal disc seat ring, the closing mechanism comprised of the disc and the disc seat ring, will swing by the hinge pin and will be closed by the weight of its own mechanism if there is no pressure or back pressure in the pipeline.

13. The tilting disc swing check valve according to claim 11, wherein a seating area is where the body seat ring touches a disc seat ring.

14. The tilting disc swing check valve according to claim 13, wherein the disc seat ring is made from a material chosen from the group consisting of: Nitrile Butadiene Rubber (NBR), Ethylene Propylene Diene Rubber (EPDM), bronze, and stainless steel.

15. The tilting disc swing check valve according to claim 13, wherein the body seat ring is made of bronze or stainless steel and is assembled to the body by compression for a valve having a rubber disc seat ring, and wherein for the valve having a metal disc seat ring, the body seat ring in the body is assembled by threading.

16. The tilting disc swing check valve according to claim 15, wherein the seating surface of the body seat ring is precisely machined to get a shining smooth surface, in order to increase the effectiveness of seating.

17. The tilting disc swing check valve according to claim 11, wherein the hinge pin is made of stainless steel and has a groove for putting a key to hold a boss of the disc tightly and centering the body seat with the disc.

18. The tilting disc swing check valve according to claim 11, wherein both of the square bosses at the left and right sides are drilled and inserted with bushes.

19. The tilting disc swing check valve according to claim 18, wherein the bushes are made of brass or bronze.

20. The tilting disc swing check valve according to claim 17, wherein the pin is made of stainless steel and can be replaced upon damage.
